(19) United States
(12) Patent Application Publication
(10) Pub. No.: US 2021/0056241 A1
(43) Pub. Date: Feb. 25, 2021

(54) DESIGN SUPPORT DEVICE AND COMPUTER READABLE MEDIUM

(71) Applicant: MITSUBISHI ELECTRIC CORPORATION, Tokyo (JP)

(72) Inventors: Koki MURANO, Tokyo (JP); Ryo YAMAMOTO, Tokyo (JP); Fumitoshi KARUBE, Tokyo (JP); Yoshihiro OGAWA, Tokyo (JP)

(73) Assignee: MITSUBISHI ELECTRIC CORPORATION, Tokyo (JP)

(21) Appl. No.: 16/967,155

(22) PCT Filed: Mar. 6, 2018
(86) PCT No.: PCT/JP2018/008549

§ 371 Date: Aug. 4, 2020

(51) Int. Cl. G06F 30/13; G06F 30/20

(52) U.S. Cl. CPC G06F 30/13; G06F 2119/02; G06F 30/20

(57) ABSTRACT

An acceptance unit accepts architecture information, a processing program, and a constraint condition. An objective function generation unit generates an objective function about an evaluation item of each constituent element indicated by the architecture information. An optimization unit solves an optimization problem of the objective function once or more to obtain one partitioning solution or more about the one constituent element or more and the one subroutine or more. A margin degree calculation unit calculates, concerning an evaluation item of each constituent element, a margin degree of each constituent element based on the one partitioning solution or more and the constraint condition. A change determination unit determines whether or not each constituent element needs to be changed, based on the margin degree of the constituent element. A change unit changes the architecture information about each constituent element that needs to be changed.

### TECHNICAL FIELD

The present invention relates to a technique for supporting architecture designing.

### BACKGROUND ART

The following operations are performed in embedded system designing.

First, requirements analysis is performed according to system requirements. Then, operation specifications of the entire system are partitioned into functional blocks. Then, operation specifications per functional block are designed. Then, components for implementing the functional blocks are selected. Specific components are a Central Processing Unit (CPU) and a Large Scale Integration (LSI). After selecting the components, the functional blocks are partitioned between software for implementing the functional blocks in the CPU and hardware for implementing the functional blocks in the LSI. Then, software and hardware are implemented.

In embedded system designing, the final implementation result needs to satisfy constraints on performance, cost, area, and so on. For this purpose, selection of components and partitioning of functional blocks are important, and knowledge of components, knowledge of software/hardware implementation, and work experience are required.

Patent Literature 1 discloses the following method as a method for partitioning functional specifications between software and hardware.

First, parameters for evaluating function partitioning are inputted. A partitioning index is calculated based on the inputted parameters. Then, the current partitioning is changed based on the calculated partitioning index.

Further, the result of the subpartitioning is evaluated by performance simulation. This processing is repeated until a constraint condition such as performance and circuit scale is satisfied. That is, a partitioning solution satisfying the constraint condition is searched for.

Non-Patent Literature 1 discloses a method of obtaining a partitioning floor by regarding partitioning of functional specifications as a combinational optimization problem.

In this method, concerning processes (subroutines) obtained by partitioning the functional specifications, whether to perform the processes by software or by hardware is determined by combinational optimization. Non-Patent Literature 1 gives suggestions not only on process partitioning of a system architecture composed of two elements, software and hardware, but also on process partitioning of a system architecture composed of three or more elements.

It is considered that a search for an embedded system architecture can be performed if a constituent element to which no process is assigned is allowed.

### CITATION LIST

### Patent Literature

Patent Literature 1: JP 2002-269163 A

### Non-Patent Literature

Non-Patent Literature 1: Ralf Niewmann, Peter Marwedel, “An Algorithm for Hardware/Software Partitioning Using Mixed Integer Linear Programming” Design Automation for Embedded Systems March 1997, Volume 2, Issue 2, pp 165-193

### SUMMARY OF INVENTION

### Technical Problem

In both the method disclosed in Patent Literature 1 and the method disclosed in Non-Patent Literature 1, it is necessary to search for an optimum system architecture and a partitioning solution from among all embedded system architecture candidates that can be realized and partitioning candidates that can be realized on the system architecture. Therefore, when a number of partitioned elements and a number of constituent elements of the embedded system architecture increase, a number of searches increases exponentially. As a result, the search prolongs.

An objective of the present invention is to enable reduction of a search time in architecture designing.

### Solution to Problem

A design support device according to the present invention includes:
an acceptance unit to accept architecture information, a processing program, and a constraint condition, the architecture information indicating one constituent element or more of an architecture and an evaluation item of each constituent element, the processing program including one subroutine or more, the constraint condition indicating a constraint value of each constituent element concerning the evaluation item of each constituent element;
an objective function generation unit to generate an objective function concerning the evaluation item of each constituent element indicated by the architecture information;
an optimization unit to solve an optimization problem of the objective function once or more to obtain one partitioning solution or more about the one constituent element or more and the one subroutine or more;
a margin degree calculation unit to calculate a margin degree of the constituent element concerning the evaluation item of each constituent element, based on the one partitioning solution or more and the constraint condition;
a change determination unit to determine whether or not each constituent element needs to be changed, based on the margin degree of each constituent element; and
the change unit to change the architecture information about each constituent element that needs to be changed.

### Advantageous Effects of Invention

According to the present invention, whether or not each constituent element needs to be changed is determined based on a margin degree of each constituent element. Therefore, it is possible to appropriately select each constituent element without searching for a partitioning solution for all combinations of one constituent element or more. This enables reduction of the search time in architecture designing.

### BRIEF DESCRIPTION OF DRAWINGS

FIG. 1 is a configuration diagram of a design support device 100 in Embodiment 1.

FIG. 2 is a flowchart of a design support method in Embodiment 1.

FIG. 3 is a diagram illustrating architecture information 121 in Embodiment 1.

FIG. 4 is a diagram illustrating a constraint condition 122 in Embodiment 1.

FIG. 5 is a flowchart of a cost calculation process (S110) in Embodiment 1.

FIG. 6 is a flowchart of an objective function generation process (S120) in Embodiment 1.

FIG. 7 is a flowchart of an optimization process (S130) in Embodiment 1.

FIG. 8 is a flowchart of a margin degree calculation process (S140) in Embodiment 1.

FIG. 9 is a diagram illustrating margin degree information 123 in Embodiment 1.

FIG. 10 is a flowchart of a change determination process (S150) in Embodiment 1.

FIG. 11 is a flowchart of the change determination process (S150) in Embodiment 1.

FIG. 12 is a diagram illustrating determination result information 124A in Embodiment 1.

FIG. 13 is a diagram illustrating determination result information 124B in Embodiment 1.

FIG. 14 is a diagram illustrating determination result information 124C in Embodiment 1.

FIG. 15 is a hardware configuration diagram of the design support device 100 in Embodiment 1.

### DESCRIPTION OF EMBODIMENTS

In the embodiment and drawings, the same element and an equivalent element are denoted by the same reference sign. An explanation on the element denoted by the same reference sign is arbitrarily omitted or simplified. Arrows in the drawings mainly illustrate data flows or process flows.

### Embodiment 1

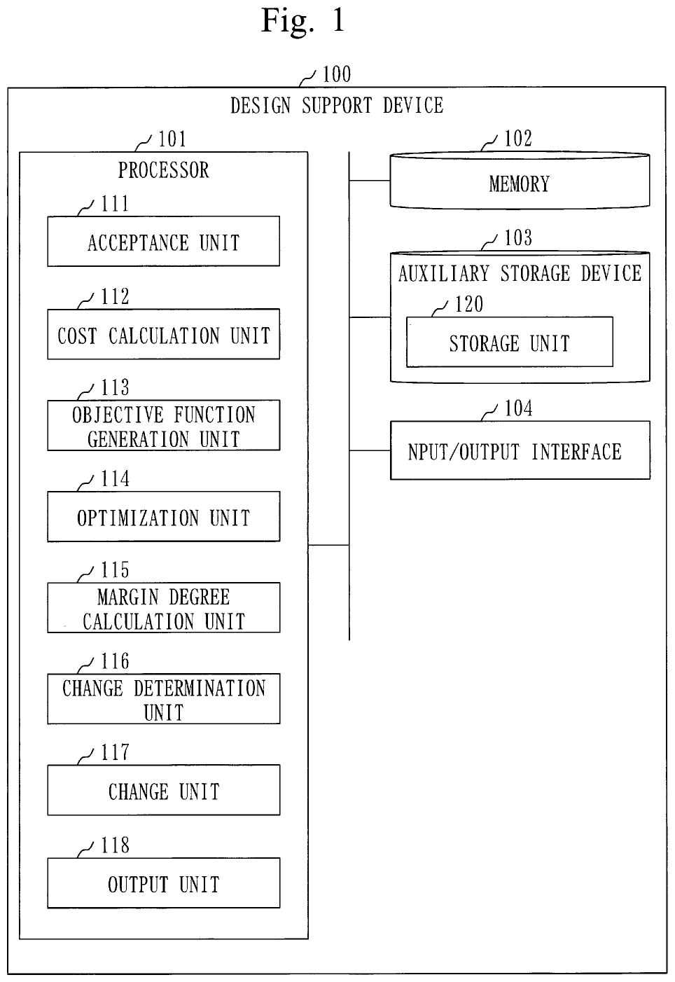

A design support device 100 will be described with referring to FIGS. 1 to 15.

### ***Description of Configuration***

A configuration of the design support device 100 will be described with referring to FIG. 1.

The design support device 100 is a computer provided with hardware devices such as a processor 101, a memory 102, an auxiliary storage device 103, and an input/output interface 104. These hardware devices are connected to each other via signal lines.

The processor 101 is an Integrated Circuit (IC) which performs computation processing and controls the other hardware devices. For example, the processor 101 is a Central Processing Unit (CPU), a Digital Signal Processor (DSP), or a Graphics Processing Unit (GPU).

The memory 102 is a volatile storage device. The memory 102 is also called main storage device or main memory. For example, the memory 102 is a Random Access Memory (RAM). Data stored in the memory 102 is saved in the auxiliary storage device 103 as necessary.

The auxiliary storage device 103 is a nonvolatile storage device. For example, the auxiliary storage device 103 is a Read Only memory (ROM), a Hard Disk Drive (HDD), or a flash memory. Data stored in the auxiliary storage device 103 is loaded to the memory 102 as necessary.

The input/output interface 104 is a port to which an input device and an output device are connected. For example, the input/output interface 104 is a USB terminal. The input device includes a keyboard and a mouse. The output device is a display. Note that USB stands for Universal Serial Bus.

The design support device 100 is provided with elements such as an acceptance unit 111, a cost calculation unit 112, an objective function generation unit 113, an optimization unit 114, a margin degree calculation unit 115, a change determination unit 116, a change unit 117, and an output unit 118. These elements are implemented by software.

A design support program is stored in the auxiliary storage device 103 to cause the computer to function as the acceptance unit 111, the cost calculation unit 112, the objective function generation unit 113, the optimization unit 114, the margin degree calculation unit 115, the change determination unit 116, the change unit 117, and the output unit 118. The design support program is loaded to the memory 102 and executed by the processor 101.

An Operating System (OS) is also stored in the auxiliary storage device 103. At least part of the OS is loaded to the memory 102 and executed by the processor 101.

That is, the processor 101 executes the design support program while executing the OS.

Data obtained by executing the design support program is stored in a storage device such as the memory 102, the auxiliary storage device 103, a register in the processor 101, and a cache memory in the processor 101.

The auxiliary storage device 103 functions as a storage unit 120. However, another storage device may function as the storage unit 120 in place of the auxiliary storage device 103 or along with the auxiliary storage device 103.

The design support device 100 may be provided with a plurality of processors that substitute for the processor 101. The plurality of processors share the role of the processor 101.

The design support program can be computer readably recorded (stored) in a nonvolatile recording medium such as an optical disk and a flash memory.

### ***Description of Operation***

An operation of the design support device 100 is equivalent to a design support method. A procedure of the design support method is equivalent to a procedure of the design support program.

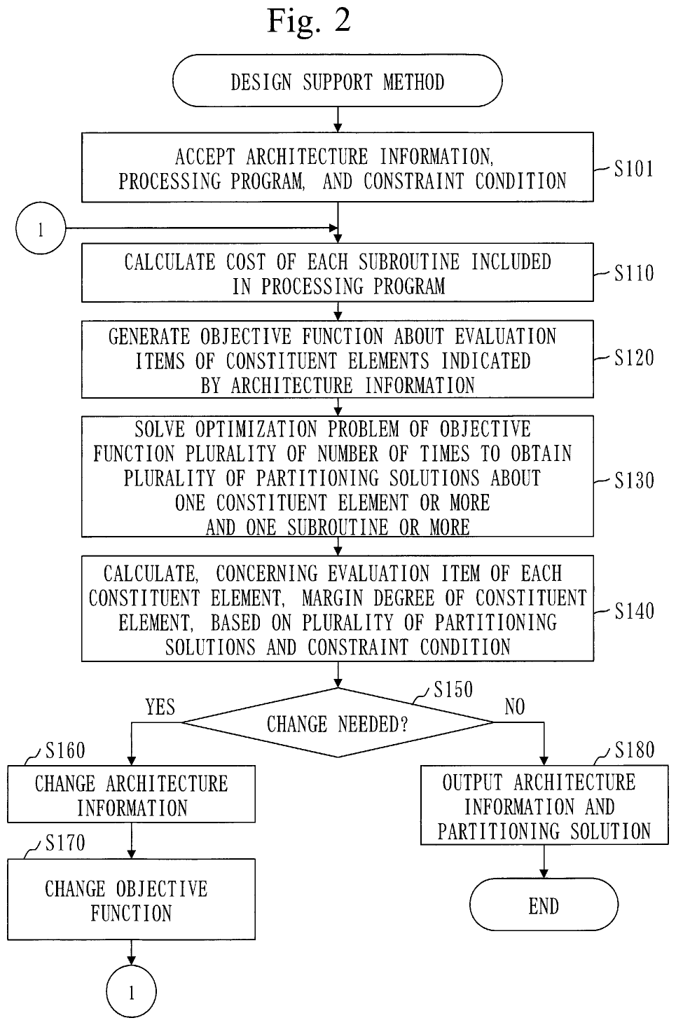

The design support method will be described with referring to FIG. 2.

In step S101, a user enters architecture information, a processing program, and a constraint condition, to the design support device 100.

The acceptance unit 111 accepts the architecture information, processing program, and constraint condition. The acceptance unit 111 then stores the architecture information, processing program, and constraint condition to the storage unit 120.

The architecture information indicates one constituent element or more of the architecture of a target system and an evaluation item of each constituent element of the target system.

The target system is a system to be designed. For example, the target system is an embedded system.

The constituent element is an element constituting the architecture. For example, the constituent element is a CPU, a Field Programmable Gate Array (FPGA), or a bus.

The evaluation item is an item subject to performance evaluation. For example, the evaluation item is a CPU processing time, an FPGA circuit scale, or a bus transfer time.

The processing program is a whole or part of a program describing a process of a design target. Specifically, the processing program is a source program described in a programming language. For example, the programming language is a C programming language.

The processing program includes one subroutine or more.

The subroutine is a chunk of processes. For example, the subroutine is a set of functions, for-loops, or formulas.

The constraint condition indicates a constraint value of each constituent element concerning the evaluation item of each constituent element.

A constraint value is a value expressing constraint on the evaluation item of each constituent element.

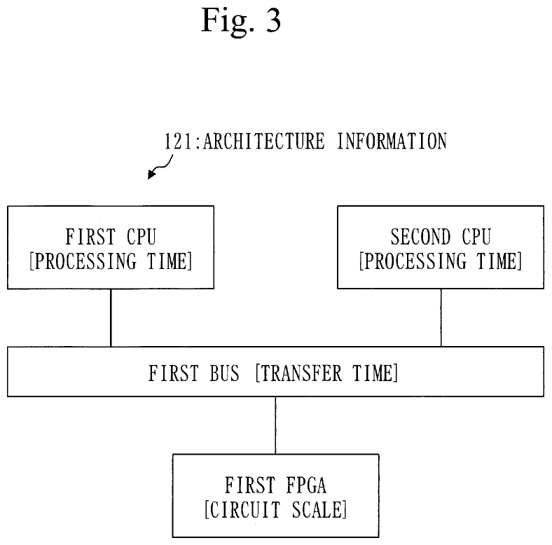

Architecture information 121 will be described with referring to FIG. 3.

The architecture information 121 is an example of the architecture information.

The architecture information 121 indicates a first CPU, a second CPU, a first bus, and a first FPGA, each as a constituent element.

An evaluation item of each of the first CPU and the second CPU is processing time.

An evaluation item of the first bus is transfer time.

An evaluation item of the first FPGA is circuit scale.

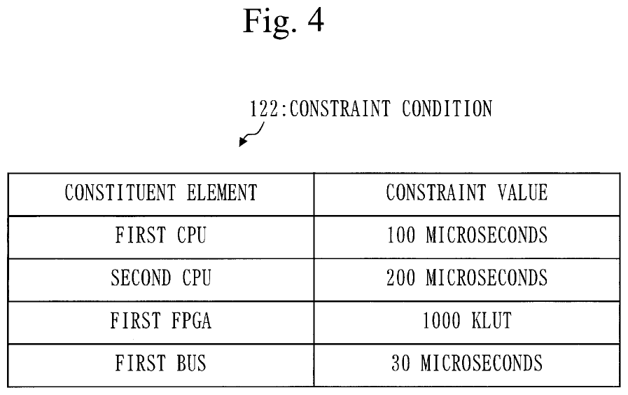

A constraint condition 122 will be described with referring to FIG. 4.

The constraint condition 122 is an example of the constraint condition.

The constraint condition 122 indicates a constraint value of each of the first CPU, the second CPU, the first FPGA, and the first bus.

The constraint value of the first CPU is 100 microseconds.

The constraint value of the second CPU is 200 microseconds.

The constraint value of the first FPGA is 1000 KLUT where KLUT stands for kilo lookup table. That is, KLUT expresses a number of lookup tables.

The constraint value of the first bus is 30 microseconds.

Back to FIG. 2, the description continues from step S110.

In step S110, the cost calculation unit 112 calculates a cost of each subroutine included in the processing program.

The cost calculation process (S110) will be described later in detail.

In step S120, the objective function generation unit 113 generates an objective function concerning the evaluation item of each constituent element indicated by the architecture information.

The objective function generation process (S120) will be described later in detail.

In step S130, the optimization unit 114 solves an optimization problem of the objective function once or more to obtain one partitioning solution or more about the one constituent element or more and the one subroutine or more.

The partitioning solution indicates subroutines assigned to the constituent elements. That is, the partitioning solution indicates what subroutine is assigned to what constituent element.

The optimization process (S130) will be described later in detail.

In step S140, the margin degree calculation unit 115 calculates a margin degree of the constituent element concerning the evaluation item of each constituent element, based on the one partitioning solution or more and the constraint condition.

The margin degree expresses a degree of margin with respect to a constraint value.

The margin degree calculation process (S140) will be described later in detail.

In step S150, the change determination unit 116 determines whether or not each constituent element needs to be changed, based on the margin degree of each constituent element.

The change determination process (S150) will be described later in detail.

If it is determined that at least one constituent element needs to be changed, the processing proceeds to step S160.

If it is determined that no constituent element needs to be changed, the processing proceeds to step S180.

In step S160, the change unit 117 changes the architecture information about each constituent element that needs to be changed.

The change process (S160) will be described later in detail.

In step S170, the change unit 117 changes the objective function based on a determination result of whether or not each constituent element needs to be changed.

The change process (S170) will be described later in detail.

In step S180, the output unit 118 outputs the architecture information and the partitioning solution.

The output process (S180) will be described later in detail.

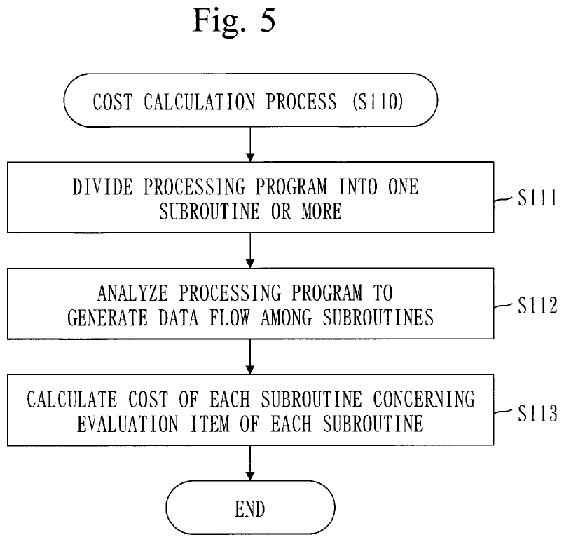

The cost calculation process (S110) will now be described with referring to FIG. 5.

In step S111, the cost calculation unit 112 divides the processing program into one subroutine or more.

In step S112, the cost calculation unit 112 analyzes the processing program to generate data flows among the subroutines.

The data flows indicate input/output of data among the subroutines.

In step S113, the cost calculation unit 112 calculates a cost of each subroutine concerning the evaluation item of each subroutine.

A cost of a subroutine is a cost of each constituent element necessary for executing the subroutine.

Specifically, the cost calculation unit 112 calculates a software cost and hardware cost per subroutine.

The software cost is a cost of a software element. The software element is a constituent element for implementing a subroutine in the form of software. For example, the software element is a CPU, and the software cost is a processing time of the CPU.

The hardware cost is a cost of a hardware element. The hardware element is a constituent element for implementing a subroutine in the form of hardware. For example, the hardware element is an FPGA, and the hardware cost is a circuit scale of the FPGA.

For example, the cost calculation unit 112 calculates the cost of each subroutine by the following method.

The cost calculation unit 112 calculates the cost of each subroutine by the method described in Patent Literature 1. Patent Literature 1 describes a method that uses a database.

The cost calculation unit 112 activates a simulator or an actual machine and measures the software cost of each subroutine.

The cost calculation unit 112 estimates the hardware cost of each subroutine by high-level synthesis.

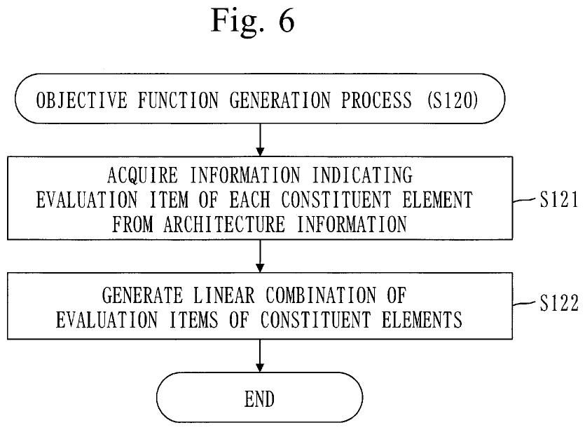

The objective function generation process (S120) will now be described with referring to FIG. 6.

In step S121, the objective function generation unit 113 acquires information indicating the evaluation item of each constituent element from the architecture information.

In step S122, the objective function generation unit 113 generates linear combination of the evaluation item of each constituent element. The generated linear combination is the objective function.

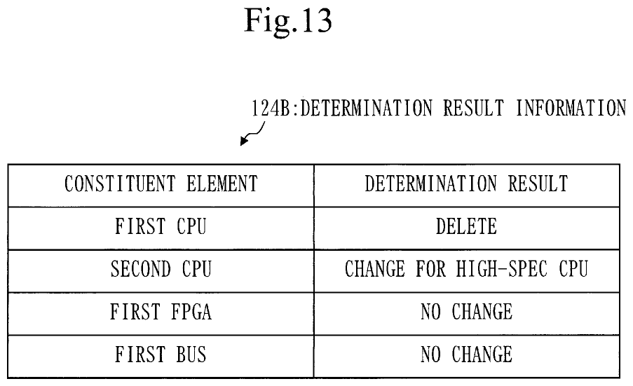

For example, the objective function generation unit 113 generates the following objective function based on the architecture information 121 of FIG. 13.

### <Objective Function >

C1×{processing time of first CPU}+C2×{processing time of second CPU}+C3×{circuit scale of first FPGA}+C4×{transfer time of first bus}→min

Note that:
each of C1 to C4 is a coefficient;
a term in parentheses { } indicates an evaluation item of a constituent element; and
a term “min” expresses a condition that the value of the objective function is minimum.

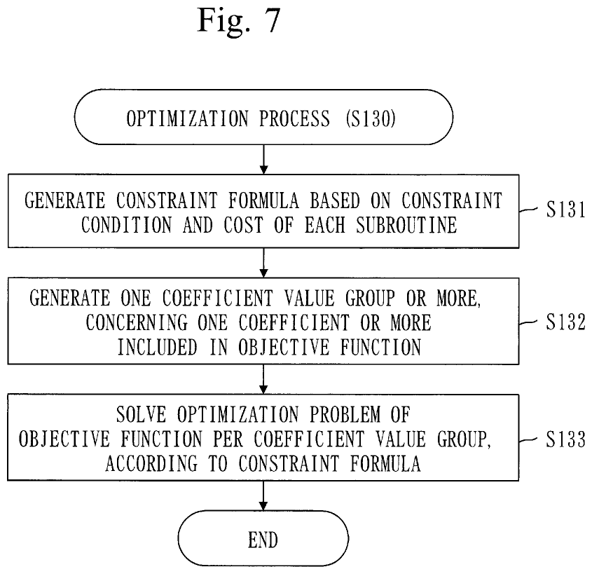

The optimization process (S130) will now be described with referring to FIG. 7.

In step S131, the optimization unit 114 generates a constraint formula based on the constraint condition and the cost of each subroutine.

Specifically, the optimization unit 114 generates the constraint formula in accordance with the method described in Non-Patent Literature 1.

In step S132, the optimization unit 114 generates one coefficient value group or more concerning one coefficient or more included in the objective function.

The coefficient value group consists of one coefficient value or more corresponding to one coefficient or more.

The coefficient value is a value being set in a coefficient.

For example, the optimization unit 114 generates eight coefficient value groups as follows concerning four coefficients included in the above-mentioned <objective function>.

C1=0, C2=C3=C4=1 (1)

Coefficient value group (1) is a coefficient value group of a case where less emphasis is placed on the first CPU. Less emphasis signifies no constraint. For example, in a case where less emphasis is placed on the first CPU, a long processing time of the first CPU will do.

C1=1, C2=C3=C4=0 (2)

Coefficient value group (2) is a coefficient value group of a case where more emphasis is placed on the first CPU. More emphasis signifies strict constraint. For example, in a case where more emphasis is placed on the first CPU, the processing time of the first CPU must be shortest.

C2=0, C1=C3=C4=1 (3)

Coefficient value group (3) is a coefficient value group of a case where less emphasis is placed on the second CPU.

C2=1, C1=C3=C4=0 (4)

Coefficient value group (4) is a coefficient value group of a case where more emphasis is placed on the second CPU.

C3=0, C1=C2=C4=1 (5)

Coefficient value group (5) is a coefficient value group of a case where less emphasis is placed on the first FPGA.

C3=1, C1=C2=C4=0 (6)

Coefficient value group (6) is a coefficient value group of a case where more emphasis is placed on the first FPGA.

C4=0, C1=C2=C3=1 (7)

Coefficient value group (7) is a coefficient value group of a case where less emphasis is placed on the first bus.

C4=1, C1=C2=C3=0 (8)

Coefficient value group (8) is a coefficient value group of a case where more emphasis is placed on the first bus.

In step S133, the optimization unit 114 solves the optimization problem of the objective function per coefficient value group, according to the constraint formula. Thus, the partitioning solution is obtained per coefficient value group.

Specifically, the optimization unit 114 solves the optimization problem using an optimization solver.

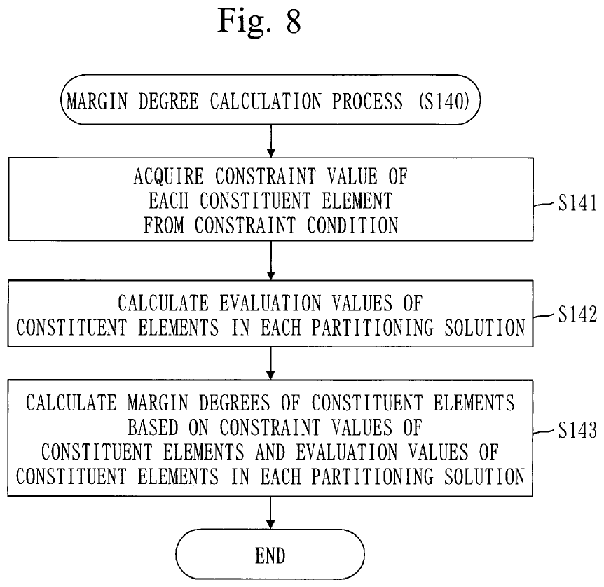

The margin degree calculation process (S140) will now be described with referring to FIG. 8.

In step S141, the margin degree calculation unit 115 acquires the constraint value of each constituent element from the constraint condition.

In step S142, the margin degree calculation unit 115 calculates evaluation values of the constituent elements in each partitioning solution. That is, the margin degree calculation unit 115 calculates the evaluation values of the constituent elements per partitioning solution.

The evaluation value is a cost of a constituent element of a case where a partitioning solution is applied.

For example, the margin degree calculation unit 115 calculates the evaluation values of the constituent elements in each partitioning solution by simulation. The margin degree calculation unit 115 may calculate the evaluation values of the constituent elements in each partitioning solution by evaluation using logic synthesis. The margin degree calculation unit 115 may also calculate the evaluation values of the constituent elements in each partitioning solution by the same method as that employed by the cost calculation unit 112 for cost calculation.

In step S143, the margin degree calculation unit 115 calculates margin degrees of the constituent elements based on the constraint values of the constituent elements and the evaluation values of the constituent elements in each partitioning solution.

The margin degree is a difference between a constraint value and an evaluation value.

Specifically, the margin degree calculation unit 115 calculates a minimum margin degree of each constituent element and a maximum margin degree of each constituent element.

The margin degree calculation unit 115 calculates the minimum margin degree of a constituent element and a maximum margin degree of the constituent element as follows.

First, the margin degree calculation unit 115 calculates a difference between a constraint value of the constituent element and an evaluation value of the constituent element, per partitioning solution. The calculated difference is the margin degree.

Then, the margin degree calculation unit 115 selects the minimum margin degree and the maximum margin degree.

For example, a constraint value about the processing time of the first CPU is 100 microseconds. In the first partitioning solution between two partitioning solutions, an evaluation value about the processing time of the first CPU is 50 microseconds. In the second partitioning solution between the two partitioning solutions, an evaluation value about the processing time of the first CPU is 40 microseconds.

In this case, a margin degree of the first CPU in the first partitioning solution is 50 (=100−50), and a margin degree of the first CPU in the second partitioning solution is 60 (=100−40).

Therefore, the minimum margin degree is 50, and the maximum margin degree is 60.

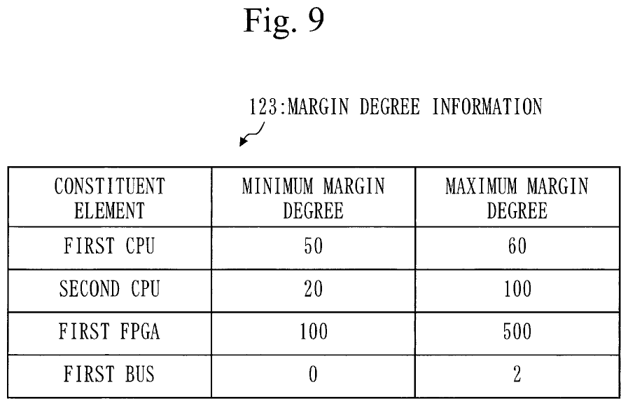

Margin degree information 123 will be described with referring to FIG. 9.

The margin degree information 123 is an example of margin degree information. The margin degree information expresses the margin degrees of the constituent elements.

The margin degree information 123 indicates the minimum margin degree and maximum margin degree of each of the first CPU, the second CPU, the first FPGA, and the first bus.

The minimum margin degree of the first CPU is 50. The maximum margin degree of the first CPU is 60.

The minimum margin degree of the second CPU is 20. The maximum margin degree of the second CPU is 100.

The minimum margin degree of the first FPGA is 100. The maximum margin degree of the first FPGA is 500.

The minimum margin degree of the first bus is 0. The maximum margin degree of the first bus is 2.

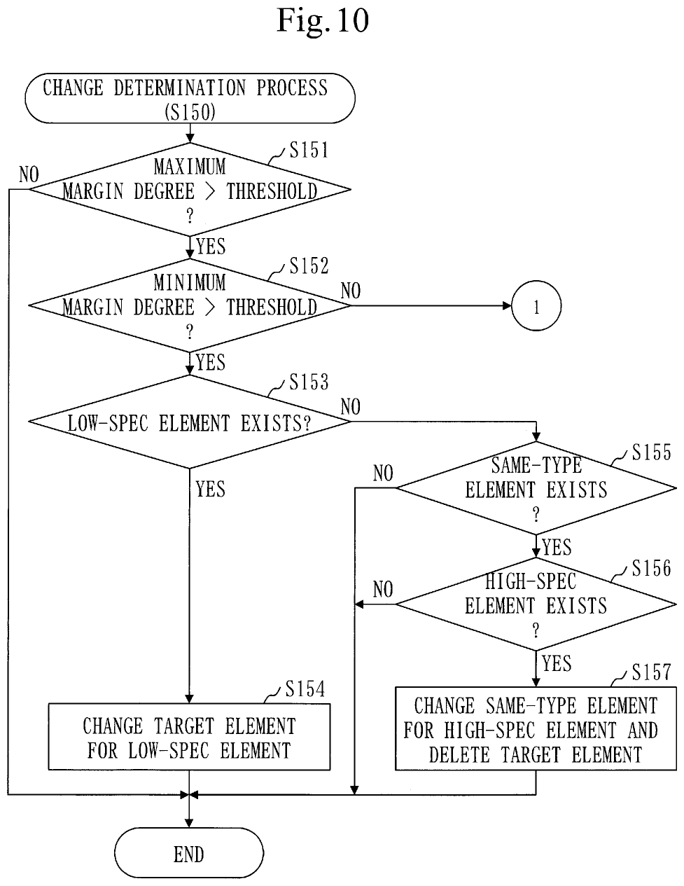

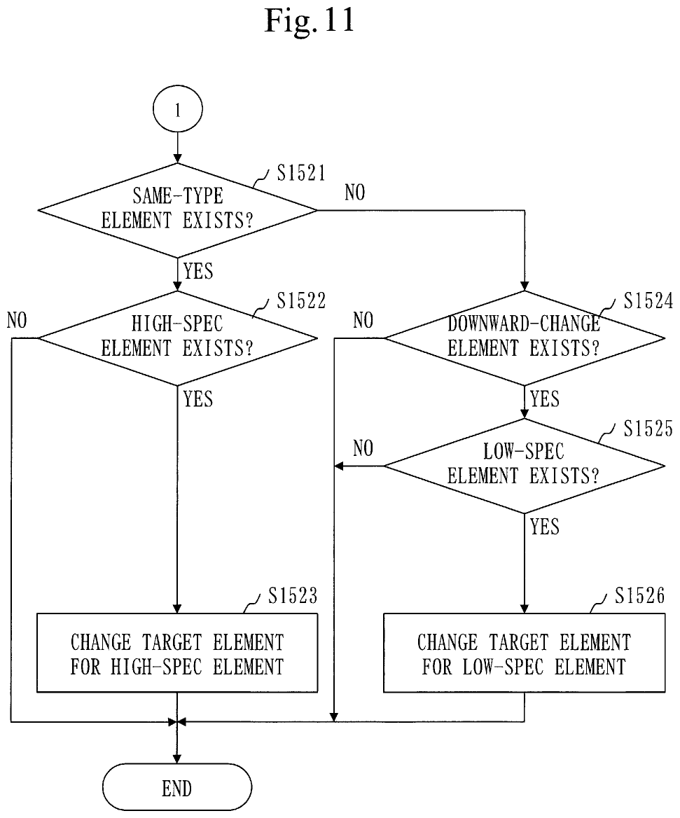

The change determination process (S150) will now be described with referring to FIGS. 10 and 11. The change determination process (S150) of FIGS. 10 and 11 is executed per constituent element.

In the change determination process (S150), a constituent element to be executed is called target element.

In the change determination process (S150), an architecture database is used. The architecture database has information on various types of architecture elements. The architecture element is an element that can serve as a constituent element. The architecture database may be provided to the design support device 100 or may be provided outside the design support device 100.

In step S151 (see FIG. 10), the change determination unit 116 compares the maximum margin degree of a target element with a margin degree threshold.

The margin degree threshold is determined in advance per type of the constituent element. The change determination unit 116 uses a margin degree threshold corresponding to the type of the target element for the purpose of comparison.

If the maximum margin degree of the target element is larger than the margin degree threshold, the processing proceeds to step S152.

If the maximum margin degree of the target element is equal to or smaller than the margin degree threshold, the change determination unit 116 determines not to change the target element, and the processing ends.

In step S152, the change determination unit 116 compares the minimum margin degree of the target element with the margin degree threshold.

If the minimum margin degree of the target element is larger than the margin degree threshold, the processing proceeds to step S153.

If the minimum margin degree of the target element is equal to or smaller than the margin degree threshold, the processing proceeds to step S1521 (see FIG. 11).

In step S153, the change determination unit 116 determines whether there exists an architecture element of the same type as the target element and of a lower spec than the target element.

In step S153 and step S154, an architecture element of the same type as the target element and of a lower spec than the target element is called low-spec element. Specifically, the change determination unit 116 inquires of the architecture database whether a low-spec element exists.

If a low-spec element exists, the processing proceeds to step S154.

If a low-spec element does not exist, the processing proceeds to step S155.

In step S154, the change determination unit 116 determines to change the target element for a low-spec element. Then, the processing ends.

In step S155, the change determination unit 116 determines whether there exists a constituent element of the same type as the target element, among one constituent element or more indicated by the architecture information.

In step S155 to step S157, a constituent element of the same type as the target element is called same-type element.

If a same-type element exists, the processing proceeds to step S156.

If a same-type element does not exist, the change determination unit 116 determines not to change the target element, and the processing ends.

In step S156, the change determination unit 116 determines whether there exists an architecture element of the same type as the same-type element and of a higher spec than the same-type element.

In step S156 and step S157, an architecture element of the same type as the same-type element and of a higher spec than the same-type element is called high-spec element.

Specifically, the change determination unit 116 inquires of the architecture database whether a high-spec element exists.

If a high-spec element exists, the processing proceeds to step S157.

If a high-spec element does not exist, the change determination unit 116 determines not to change the target element, and the processing ends.

In step S157, the change determination unit 116 determines to change the same-type element for a high-spec element and to delete the target element. Then, the processing ends.

In step S1521 (see FIG. 11), the change determination unit 116 determines whether there exists a constituent element of the same type as the target element, among the one constituent element or more indicated by the architecture information.

In step S1521, a constituent element of the same type as the target element is called same-type element.

If a same-type element exists, the processing proceeds to step S1522.

If a same-type element does not exist, the processing proceeds to step S1524.

In step S1522, the change determination unit 116 determines whether there exists an architecture element of the same type as the target element and of a higher spec than the target element.

In step S1522 and step S1523, an architecture element of the same type as the target element and of a higher spec than the target element is called high-spec element.

Specifically, the change determination unit 116 inquires of the architecture database whether a high-spec element exists.

If a high-spec element exists, the processing proceeds to step S1523.

If a high-spec element does not exist, the change determination unit 116 determines not to change the target element, and the processing ends.

In step S1523, the change determination unit 116 determines to change the target element for a high-spec element. Then, the processing ends.

In step S1524, the change determination unit 116 determines whether there exists a constituent element of the same type as the target element and which is to be changed for a low-spec architecture element, among the one constituent element or more indicated by the architecture information.

In step S1524, a constituent element of the same type as the target element and which is to be changed for a low-spec architecture element is called downward-change element. That is, a downward-change element is a constituent element subject to downward spec change.

If a downward-change element exists, the processing proceeds to step S1525.

If a downward-change element does not exist, the change determination unit 116 determines not to change the target element, and the processing ends.

In step S1525, the change determination unit 116 determines whether there is an architecture element of the same type as the target element and of a lower spec than the target element.

In step S1525 and step S1526, an architecture element of the same type as the target element and of a lower spec than the target element is called a low-spec element.

Specifically, the change determination unit 116 inquires of the architecture database whether a low-spec element exists.

If a low-spec element exists, the processing proceeds to step S1526.

If a low-spec element does not exist, the change determination unit 116 determines not to change the target element, and the processing ends.

In step S1526, the change determination unit 116 determines to change the target element for a low-spec element. Then, the processing ends.

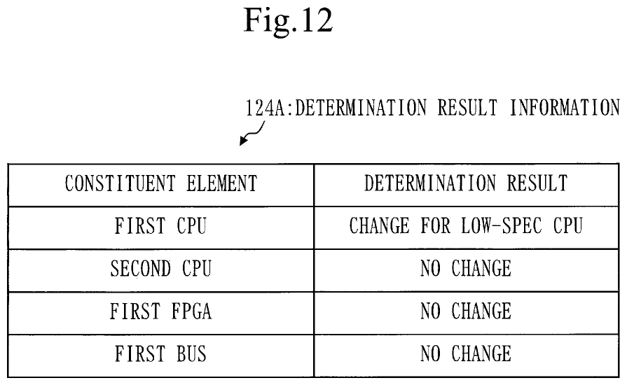

Determination result information 124A will be described with referring to FIG. 12.

The determination result information 124A is an example of determination result information. The determination result information indicates determination results of the change determination process (S150).

The determination result information 124A indicates a determination result of each of the first CPU, the second CPU, the first FPGA, and the first bus.

The first CPU will be changed for a CPU of a lower spec than the present CPU.

The second CPU, the first FPGA, and the first bus will not be changed.

The determination result information 124A is obtained in the following situation.

There exists a CPU of a lower spec than the present spec of the first CPU. The maximum margin degree of the first CPU and the minimum margin degree of the first CPU are each larger than the margin degree threshold. In this case, the change determination unit 116 determines to change the first CPU for a CPU of a lower spec than the present CPU. The maximum margin degrees of the second CPU and first FPGA are each larger than the margin degree threshold, but the minimum margin degree of each of the second CPU and first FPGA is smaller than the margin degree threshold. Therefore, if the spec of each of the second CPU and first FPGA is lowered, there is a possibility that the spec margin will run out. In this case, the change determination unit 116 determines not to change each of the second CPU and first FPGA. The maximum margin degree of the first bus and the minimum margin degree of the first bus are each smaller than the margin degree threshold. In this case, the change determination unit 116 determines not to change the first bus.

Determination result information 124B will be described with referring to FIG. 13.

The determination result information 124B is an example of the determination result information.

The determination result information 124B indicates a determination result of each of the first CPU, the second CPU, the first FPGA, and the first bus.

The first CPU will be deleted.

The second CPU will be changed for a CPU of a higher spec than the present CPU.

Both the first FPGA and the first bus will not be changed.

The determination result information 124B is obtained in the following situation.

There exists no CPU of a lower spec than the first CPU. Therefore, the first CPU cannot be changed for a CPU of a lower spec than the present CPU. The minimum margin degree of the second CPU is smaller than the margin degree threshold. Therefore, there is a possibility that if a subroutine having been assigned to the first CPU is assigned to the second CPU in place of the first CPU, the spec margin of the second CPU will run out. However, there exists a CPU of a higher spec than the second CPU. In this case, the change determination unit 116 determines to delete that the first CPU and to change the second CPU for a CPU of a higher spec than the present CPU, in order to assign the subroutine having been assigned to the first CPU, to the second CPU in place of the first CPU.

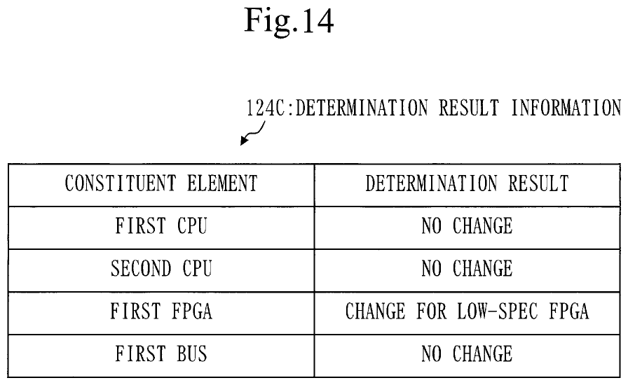

Determination result information 124C will be described with referring to FIG. 14.

The determination result information 124C is an example of the determination result information.

The determination result information 124C indicates a determination result of each of the first CPU, the second CPU, the first FPGA, and the first bus.

Each of the first CPU, the second CPU, and the first bus will not be changed.

The first FPGA will be changed for an FPGA of a lower spec than the present FPGA.

The determination result information 124C is obtained in the following situation.

There are no other CPUs that can be usable as the first CPU and the second CPU. Therefore, the change determination unit 116 determines not to change each of the first CPU and the second CPU. An FPGA of a lower spec than the first FPGA exists. The maximum margin degree of the first FPGA and the minimum margin degree of the first FPGA are each larger than the margin degree threshold. In this case, the change determination unit 116 determines to change the first FPGA for an FPGA of a lower spec than the present FPGA.

The change process (S160) will now be described.

In step S160, the change unit 117 changes the architecture information about each constituent element that needs to be changed.

Specifically, the change unit 117 changes the architecture information as follows. In the description below, a constituent element that needs to be changed is called a target element.

The change unit 117 acquires information on an architecture element that will be a post-change target element, from the architecture database.

The change unit 117 selects information on the target element from the architecture information.

Then, the change unit 117 changes the selected information for the acquired information.

The change process (S170) will now be described.

In step S170, the change unit 117 changes the objective function based on the determination result information.

Specifically, the change unit 117 changes the objective function as follows.

The change unit 117 selects an evaluation item about a constituent element that will not be changed, from the objective function. Then, the change unit 117 deletes the selected evaluation item from the objective function.

The change unit 117 selects an evaluation item about a constituent element that will be deleted, from the objective function. Then, the change unit 117 deletes the selected evaluation item from the objective function.

A change example of the objective function will be described.

When the maximum margin degree and minimum margin degree of a constituent element are both smaller than the margin degree threshold, this constituent element has an appropriate spec and accordingly is an appropriate element. Since a search for this constituent element has been completed, it is not necessary to re-evaluate this constituent element. Hence, the change unit 117 deletes the evaluation item of the constituent element that will not be changed, from the objective function. As a result, a number of times the optimization problem is solved is reduced, and the search time is shortened.

For example, when the maximum margin degree of the first FPGA and the minimum margin degree of the first FPGA are both smaller than the margin degree threshold, the change unit 117 changes the <objective function > as follows.

### <Post-Change Objective Function>

C1×{processing time of first CPU}+C2×{processing time of second CPU}+C4×{transfer time of first bus}→min

The output process (S180) will now be described.

In step S180, the output unit 118 outputs the architecture information and the partitioning solution.

For example, the output unit 118 displays the architecture information and the partitioning solution to a display.

In execution of step S180, the architecture information indicates one appropriate constituent element or more. Also, in the immediately preceding optimization process (130), one or a plurality of optimum partitioning solutions can be obtained. If a plurality of partitioning solutions are obtained, the output unit 118 may output all of the plurality of partitioning solutions, or may output any one partitioning solution or more.

### ***Effect of Embodiment 1***

An objective function having an evaluation item of each constituent element is generated. A partitioning solution is obtained by solving the optimization problem of the objective function. Margin degrees of the constituent elements are calculated per partitioning solution, and whether each constituent element needs to be changed is determined based on the margin degree of each constituent element. It is thus no longer necessary to search for all candidates of the partitioning solution. Hence, a total search quantity related to optimization of the partitioning solution can be reduced.

Constituent elements with smaller search ranges are determined based on the margin degrees of the constituent elements. In other words, a constituent element that will not be changed is determined. Then, the evaluation item of this constituent element is deleted from the objective function. This constituent element will no longer be searched for. Namely, unnecessary search will not be performed. As a result, a search quantity per iteration can be reduced.

### ***Other Configurations***

The objective function need not be a linear combination of the evaluation items of the constituent elements. For example, the similar evaluation formula as in the prior art may be utilized as an objective function.

### ***Supplement to Embodiment***

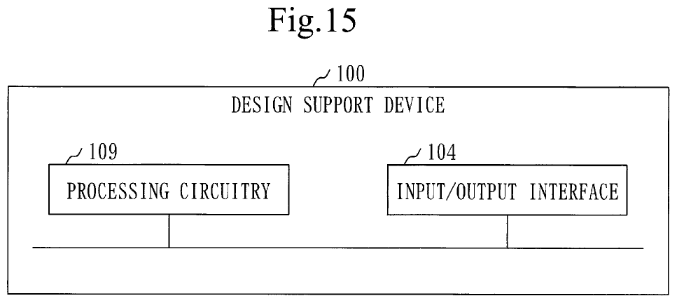

A hardware configuration of the design support device 100 will be described with referring to FIG. 15.

The design support device 100 is provided with processing circuitry 109.

The processing circuitry 109 is hardware that implements the acceptance unit 111, cost calculation unit 112, objective function generation unit 113, optimization unit 114, margin degree calculation unit 115, change determination unit 116, change unit 117, and output unit 118.

The processing circuitry 109 may be dedicated hardware, or may be a processor 101 that implements the program stored in the memory 102.

If the processing circuitry 109 is dedicated hardware, the processing circuitry 109 is, for example, a single circuit, a composite circuit, a programmed processor, a parallel-programmed processor, an ASIC, or an FPGA; or a combination of them.

Note that ASIC stands for Application Specific Integrated Circuit, and FPGA stands for Field Programmable Gate Array.

The design support device 100 may be provided with a plurality of processing circuitries that substitute for the processing circuitry 109. The plurality of processing circuitries share a role of the processing circuitry 109.

In the processing circuitry 109, some of its functions may be implemented by dedicated hardware, while the remaining functions may be implemented by software or firmware.

In this manner, the processing circuitry 109 can be implemented by hardware, software, or firmware; or a combination of them.

The embodiment is an exemplification of a preferred mode, and is not intended to limit the technical scope of the present invention. The embodiment may be practiced partly, or may be practiced in combination with another embodiment. Procedures explained with using flowcharts or the like may be changed as necessary.

### REFERENCE SIGNS LIST

100: design support device; 101: processor; 102: memory; 103: auxiliary storage device; 104: input/output interface; 109: processing circuitry; 111: acceptance unit; 112: cost calculation unit; 113: objective function generation unit; 114: optimization unit; 115: margin degree calculation unit; 116: change determination unit; 117: change unit; 118: output unit; 120: storage unit; 121: architecture information; 122: constraint condition; 123: margin degree information; 124: determination result information.

1. A design support device comprising:
processing circuitry
to accept architecture information, a processing program, and a constraint condition, the architecture information indicating one constituent element or more of an architecture and an evaluation item of each constituent element, the processing program including one subroutine or more, the constraint condition indicating a constraint value of each constituent element concerning the evaluation item of each constituent element,
to generate an objective function concerning the evaluation item of each constituent element indicated by the architecture information,
to solve an optimization problem of the objective function once or more to obtain one partitioning solution or more about the one constituent element or more and the one subroutine or more,
to calculate a margin degree of the constituent element concerning the evaluation item of each constituent element, based on the one partitioning solution or more and the constraint condition,
to determine whether or not each constituent element needs to be changed, based on the margin degree of each constituent element, and
to change the architecture information about each constituent element that needs to be changed.

2. The design support device according to claim 1,
wherein the processing circuitry generates linear combination of the evaluation item of each constituent element, as the objective function.

3. The design support device according to claim 1,
wherein the processing circuitry
calculates a maximum margin degree and a minimum margin degree, as margin degrees of each constituent element, and
compares each of a maximum margin degree of a target element and a minimum margin degree of the target element, with a margin degree threshold, and determines whether or not the target element needs to be changed, based on a comparison result.

4. The design support device according to claim 3,
wherein if the maximum margin degree of the target element and the minimum margin degree of the target element are each larger than the margin degree threshold, and if there exists a low-spec element which is an architecture element of a lower spec than the target element, then the processing circuitry determines to change the target element for the low-spec element.

5. The design support device according to claim 4,
wherein if the maximum margin degree of the target element and the minimum margin degree of the target element are each larger than the margin degree threshold, if the low-spec element does not exist, if there exists a same-type element which is a constituent element of a same type as the target element, and if there exists a high-spec element which is an architecture element of a higher spec than the same-type element, then the processing circuitry determines to change the same-type element for the high-spec element and to delete the target element.

6. The design support device according to claim 4,
wherein if the maximum margin degree of the target element is larger than the margin degree threshold, if the minimum margin degree of the target element is smaller than the margin degree threshold, if there exists a same-type element which is a constituent element of a same type as the target element, and if there exists a high-spec element which is an architecture element of a higher spec than the target element, then the processing circuitry determines to change the target element for the high-spec element.

7. The design support device according to claim 6,
wherein if the maximum margin degree of the target element is larger than the margin degree threshold, if the minimum margin degree of the target element is smaller than the margin degree threshold, if the same-type element does not exists, if there exists a downward-change element which is a constituent element subject to downward spec change, and if there exists a high-spec element which is an architecture element of a higher spec than the target element, then the processing circuitry determines to change the target element for the low-spec element.

8. The design support device according to claim 1,
wherein the processing circuitry changes the objective function based on a determination result of whether or not each constituent element needs to be changed.

9. The design support device according to claim 8,
wherein the processing circuitry deletes an evaluation item about a constituent element that will not be changed, from the objective function.

10. The design support device according to claim 1, wherein the processing circuitry outputs the architecture information and the one partitioning solution or more when it is determined that any constituent element need not be changed.

11. A non-transitory computer readable storing medium storing a design support program which causes a computer to execute:
an acceptance process of accepting architecture information, a processing program, and a constraint condition, the architecture information indicating one constituent element or more of an architecture and an evaluation item of each constituent element, the processing program including one subroutine or more, the constraint condition indicating a constraint value of each constituent element concerning the evaluation item of each constituent element;
an objective function generation process of generating an objective function concerning the evaluation item of each constituent element indicated by the architecture information;
an optimization process of solving an optimization problem of the objective function once or more to obtain one partitioning solution or more about the one constituent element or more and the one subroutine or more;
a margin degree calculation process of calculating a margin degree of the constituent element concerning the evaluation item of each constituent element, based on the one partitioning solution or more and the constraint condition;
a change determination process of determining whether or not each constituent element needs to be changed, based on the margin degree of each constituent element; and
a change process of changing the architecture information about each constituent element that needs to be changed.
